(19) United States
(12) Patent Application Publication
(10) Pub. No.: US 2026/0037656 A1
(43) Pub. Date: Feb. 5, 2026

(54) EXTRA-ORGANIZATIONAL APPLICATION MANAGEMENT

(71) Applicant: OKTA, INC., SAN FRANCISCO, CA (US)

(72) Inventors: Neelav RANA, Los Gatos, CA (US); John Robinson WARD, New York, NY (US); Jack HIRSCH, Oakland, CA (US)

(21) Appl. No.: 18/791,137

(22) Filed: Jul. 31, 2024

(51) Int. Cl. G06F 21/62; G06F 21/31; H04L 67/306

(52) U.S. Cl. CPC G06F 21/6218; G06F 21/31; H04L 67/306

(57) ABSTRACT

An identity management system may receive one or more signals associated with a sign-in to a first application via a first user profile of an organization of the identity management system. The first application may be disassociated with first applications having been authorized access by an administrator of the organization via the identity management system. The identity management system may generate a report indicative of second applications accessed via user profiles of the organization, user profiles that accessed the second applications, and a timestamp of access to the second applications by each of the user profiles, where the second applications include the first application, and where the user profiles include the first user profile. The identity management system may perform an application management operation associated with an application of the second applications, a user profile of the user profiles, or both based on generating the report.

### FIELD OF TECHNOLOGY

The present disclosure relates generally to identity management, and more specifically to extra-organizational application management.

### BACKGROUND

An identity management system may be employed to manage and store various forms of user data, including usernames, passwords, email addresses, permissions, roles, group memberships, etc. The identity management system may provide authentication services for applications, devices, users, and the like. The identity management system may enable organizations to manage and control access to resources, for example, by serving as a central repository that integrates with various identity sources. The identity management system may provide an interface that enables users to access a multitude of applications with a single set of credentials. In some cases, a user of an organization may sign in to an application that is not in a set of applications managed by the organization via the identity management system.

### SUMMARY

A method for managing application access by an organization via an identity management system is described. The method may include receiving one or more signals associated with a sign-in to a first application via a first user profile of the organization, where the first application is disassociated with a first set of multiple applications having been authorized access by an administrator of the organization via the identity management system, generating a report indicative of a second set of multiple applications accessed via user profiles of the organization, a set of multiple user profiles that accessed the second set of multiple applications, and a timestamp of access to the second set of multiple applications by each of the set of multiple user profiles, where the second set of multiple applications include at least the first application, and where the set of multiple user profiles include at least the first user profile, and performing an application management operation associated with at least one application of the second set of multiple applications, at least one user profile of the set of multiple user profiles, or both based on generating the report.

An organization via an identity management system for managing application access is described. The organization via an identity management system may include one or more memories storing processor executable code, and one or more processors coupled with the one or more memories. The one or more processors may individually or collectively be operable to execute the code to cause the organization via an identity management system to receive one or more signals associated with a sign-in to a first application via a first user profile of the organization, where the first application is disassociated with a first set of multiple applications having been authorized access by an administrator of the organization via the identity management system, generate a report indicative of a second set of multiple applications accessed via user profiles of the organization, a set of multiple user profiles that accessed the second set of multiple applications, and a timestamp of access to the second set of multiple applications by each of the set of multiple user profiles, where the second set of multiple applications include at least the first application, and where the set of multiple user profiles include at least the first user profile, and perform an application management operation associated with at least one application of the second set of multiple applications, at least one user profile of the set of multiple user profiles, or both based on generating the report.

Another organization via an identity management system for managing application access is described. The organization via an identity management system may include means for receiving one or more signals associated with a sign-in to a first application via a first user profile of the organization, where the first application is disassociated with a first set of multiple applications having been authorized access by an administrator of the organization via the identity management system, means for generating a report indicative of a second set of multiple applications accessed via user profiles of the organization, a set of multiple user profiles that accessed the second set of multiple applications, and a timestamp of access to the second set of multiple applications by each of the set of multiple user profiles, where the second set of multiple applications include at least the first application, and where the set of multiple user profiles include at least the first user profile, and means for performing an application management operation associated with at least one application of the second set of multiple applications, at least one user profile of the set of multiple user profiles, or both based on generating the report.

A non-transitory computer-readable medium storing code for managing application access is described. The code may include instructions executable by one or more processors to receive one or more signals associated with a sign-in to a first application via a first user profile of the organization, where the first application is disassociated with a first set of multiple applications having been authorized access by an administrator of the organization via the identity management system, generate a report indicative of a second set of multiple applications accessed via user profiles of the organization, a set of multiple user profiles that accessed the second set of multiple applications, and a timestamp of access to the second set of multiple applications by each of the set of multiple user profiles, where the second set of multiple applications include at least the first application, and where the set of multiple user profiles include at least the first user profile, and perform an application management operation associated with at least one application of the second set of multiple applications, at least one user profile of the set of multiple user profiles, or both based on generating the report.

In some examples of the method, organization via an identity management systems, and non-transitory computer-readable medium described herein, performing the application management operation may include operations, features, means, or instructions for configuring, by the administrator of the organization via the identity management system, the at least one application to may have authorized access, where the first set of multiple applications includes the at least one application based on configuring the at least one application to may have authorized access.

Some examples of the method, organization via an identity management systems, and non-transitory computer-readable medium described herein may further include operations, features, means, or instructions for performing the application management operation includes revoking access to the at least one application.

Some examples of the method, organization via an identity management systems, and non-transitory computer-readable medium described herein may further include operations, features, means, or instructions for receiving, via an administrator dashboard of the identity management system, one or more second signals associated with revoking access to the at least one application.

Some examples of the method, organization via an identity management systems, and non-transitory computer-readable medium described herein may further include operations, features, means, or instructions for receiving one or more second signals associated with a sign-in attempt to the at least one application, where the sign-in attempt may be unsuccessful based on revoking access to the at least one application.

In some examples of the method, organization via an identity management systems, and non-transitory computer-readable medium described herein, the application management operation may be performed based on a threshold quantity of user profiles accessing the at least one application.

Some examples of the method, organization via an identity management systems, and non-transitory computer-readable medium described herein may further include operations, features, means, or instructions for transmitting one or more application programming interface (API) calls to a provider associated with the user profiles of the organization, where generating the report indicative of the second set of multiple applications accessed via the user profiles of the organization may be based on transmitting the one or more API calls.

In some examples of the method, organization via an identity management systems, and non-transitory computer-readable medium described herein, the one or more signals may be received via a browser extension installed in a browser of a first user device associated with the first user profile of the organization.

In some examples of the method, organization via an identity management systems, and non-transitory computer-readable medium described herein, the one or more signals may be received based on an input to the first application for the sign-in having a same username as the first user profile of the organization.

In some examples of the method, organization via an identity management systems, and non-transitory computer-readable medium described herein, the one or more signals include a domain of the first application.

In some examples of the method, organization via an identity management systems, and non-transitory computer-readable medium described herein, the application management operation may be determined via an artificial intelligence (AI) model.

### BRIEF DESCRIPTION OF THE DRAWINGS

FIGS. 1 and 2 show examples of computing system diagrams that support extra-organizational application management in accordance with aspects of the present disclosure.

FIG. 3 shows an example of a process flow that supports extra-organizational application management in accordance with aspects of the present disclosure.

FIG. 4 shows a block diagram of an apparatus that supports extra-organizational application management in accordance with aspects of the present disclosure.

FIG. 5 shows a block diagram of an application access manager that supports extra-organizational application management in accordance with aspects of the present disclosure.

FIG. 6 shows a diagram of a system including a device that supports extra-organizational application management in accordance with aspects of the present disclosure.

FIGS. 7 and 8 show flowcharts illustrating methods that support extra-organizational application management in accordance with aspects of the present disclosure.

### DETAILED DESCRIPTION

An identity management system may support one or more organizations. For example, the identity management system may provide authentication services and enable administrators of organizations to manage access to resources and applications by users. As an example, an organization may manage access to a set of applications for users of the organization via the identity management system, such as via a dashboard of a user interface of the identity management system. However, in some cases, users may sign in to applications that are not managed by the organization using a user profile of the organization. For example, users may sign in to an application that is disassociated with the set of applications having managed or authorized access by an administrator of the organization. In such cases, the application may access information associated with the user profile and the organization without authorization from the administrator of the organization. Such access by the application which is not managed by the organization may be associated with security threats to the organization, as data may be accessed by an unauthorized party via the unmanaged application.

As described herein, the identity management system may support notification of and access to information associated with access by users of an organization to applications disassociated with the organization. For example, the identity management system may receive notifications of access to unauthorized applications, such as via a browser extension of the identity management system. Additionally, or alternatively, the identity management system may generate a report that includes which unauthorized applications were accessed by users of the organization, which user profiles accessed the unauthorized applications, and timestamps of access to the unauthorized applications. Based on the report, an administrator of the organization may perform an application management operation. As an example, the application management operation may be revoking access to applications via user profiles of the organization. Alternatively, the application management operation may be including previously unauthorized applications in the set of applications having managed access by the organization.

Aspects of the disclosure are initially described in the context of computing systems. Aspects of the disclosure are also illustrated by and described with reference to a process flow. Aspects of the disclosure are further illustrated by and described with reference to apparatus diagrams, system diagrams, and flowcharts that relate to extra-organizational application management.

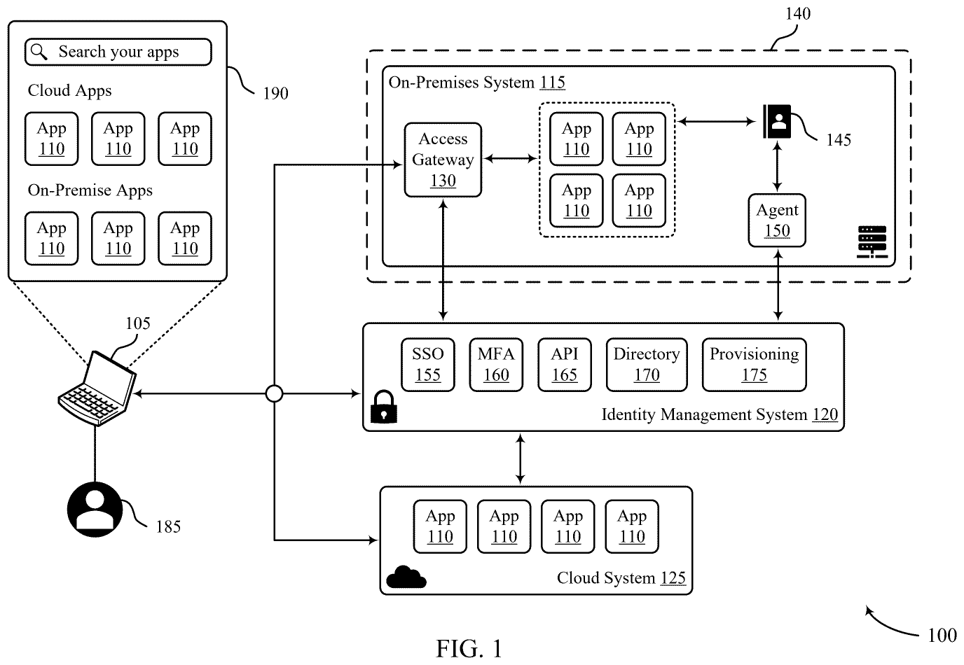

FIG. 1 illustrates an example of a computing system 100 that supports extra-organizational application management in accordance with various aspects of the present disclosure. The computing system 100 includes a computing device 105 (such as a desktop, laptop, smartphone, tablet, or the like), an on-premises system 115, an identity management system 120, and a cloud system 125, which may communicate with each other via a network, such as a wired network (e.g., the Internet), a wireless network (e.g., a cellular network, a wireless local area network (WLAN)), or both. In some cases, the network may be implemented as a public network, a private network, a secured network, an unsecured network, or any combination thereof. The network may include various communication links, hubs, bridges, routers, switches, ports, or other physical and/or logical network components, which may be distributed across the computing system 100.

The on-premises system 115 (also referred to as an on-premises infrastructure or environment) may be an example of a computing system in which a client organization owns, operates, and maintains its own physical hardware and/or software resources within its own data center(s) and facilities, instead of using cloud-based (e.g., off-site) resources. Thus, in the on-premises system 115, hardware, servers, networking equipment, and other infrastructure components may be physically located within the “premises” of the client organization, which may be protected by a firewall 140 (e.g., a network security device or software application that is configured to monitor, filter, and control incoming/outgoing network traffic). In some examples, users may remotely access or otherwise utilize compute resources of the on-premises system 115, for example, via a virtual private network (VPN).

In contrast, the cloud system 125 (also referred to as a cloud-based infrastructure or environment) may be an example of a system of compute resources (such as servers, databases, virtual machines, containers, and the like) that are hosted and managed by a third-party cloud service provider using third-party data center(s), which can be physically co-located or distributed across multiple geographic regions. The cloud system 125 may offer high scalability and a wide range of managed services, including (but not limited to) database management, analytics, machine learning (ML), artificial intelligence (AI), etc. Examples of cloud systems 125 include (AMAZON WEB SERVICES) AWS®, MICROSOFT AZURE®, GOOGLE CLOUD PLATFORM®, ALIBABA CLOUD®, ORACLE® CLOUD INFRASTRUCTURE (OCI), and the like.

The identity management system 120 may support one or more services, such as a single sign-on (SSO) service 155, a multi-factor authentication (MFA) service 160, an application programming interface (API) service 165, a directory management service 170, or a provisioning service 175 for various on-premises applications 110 (e.g., applications 110 running on compute resources of the on-premises system 115) and/or cloud applications 110 (e.g., applications 110 running on compute resources of the cloud system 125), among other examples of services. The SSO service 155, the MFA service 160, the API service 165, the directory management service 170, and/or the provisioning service 175 may be individually or collectively provided (e.g., hosted) by one or more physical machines, virtual machines, physical servers, virtual (e.g., cloud) servers, data centers, or other compute resources managed by or otherwise accessible to the identity management system 120.

A user 185 may interact with the computing device 105 to communicate with one or more of the on-premises system 115, the identity management system 120, or the cloud system 125. For example, the user 185 may access one or more applications 110 by interacting with an interface 190 of the computing device 105. In some implementations, the user 185 may be prompted to provide some form of identification (such as a password, personal identification number (PIN), biometric information, or the like) before the interface 190 is presented to the user 185. In some implementations, the user 185 may be a developer, customer, employee, vendor, partner, or contractor of a client organization (such as a group, business, enterprise, non-profit, or startup that uses one or more services of the identity management system 120). The applications 110 may include one or more on-premises applications 110 (hosted by the on-premises system 115), mobile applications 110 (configured for mobile devices), and/or one or more cloud applications 110 (hosted by the cloud system 125).

The SSO service 155 of the identity management system 120 may allow the user 185 to access multiple applications 110 with one or more credentials. Once authenticated, the user 185 may access one or more of the applications 110 (for example, via the interface 190 of the computing device 105). That is, based on the identity management system 120 authenticating the identity of the user 185, the user 185 may obtain access to multiple applications 110, for example, without having to re-enter the credentials (or enter other credentials). The SSO service 155 may leverage one or more authentication protocols, such as Security Assertion Markup Language (SAML) or OpenID Connect (OIDC), among other examples of authentication protocols. In some examples, the user 185 may attempt to access an application 110 via a browser. In such examples, the browser may be redirected to the SSO service 155 of the identity management system 120, which may serve as the identity provider (IdP). For example, in some implementations, the browser (e.g., the user's request communicated via the browser) may be redirected by an access gateway 130 (e.g., a reverse proxy-based virtual application configured to secure web applications 110 that may not natively support SAML or OIDC).

In some examples, the access gateway 130 may support integrations with legacy applications 110 using hypertext transfer protocol (HTTP) headers and Kerberos tokens, which may offer universal resource locator (URL)-based authorization, among other functionalities. In some examples, such as in response to the user's request, the IdP may prompt the user 185 for one or more credentials (such as a password, PIN, biometric information, or the like) and the user 185 may provide the requested authentication credentials to the IdP. In some implementations, the IdP may leverage the MFA service 160 for added security. The IdP may verify the user's identity by comparing the credentials provided by the user 185 to credentials associated with the user's account. For example, one or more credentials associated with the user's account may be registered with the IdP (e.g., previously registered, or otherwise authorized for authentication of the user's identity via the IdP). The IdP may generate a security token (such as a SAML token or Oath 2.0 token) containing information associated with the identity and/or authentication status of the user 185 based on successful authentication of the user's identity.

The IdP may send the security token to the computing device 105 (e.g., the browser or application 110 running on the computing device 105). In some examples, the application 110 may be associated with a service provider (SP), which may host or manage the application 110. In such examples, the computing device 105 may forward the token to the SP. Accordingly, the SP may verify the authenticity of the token and determine whether the user 185 is authorized to access the requested applications 110. In some examples, such as examples in which the SP determines that the user 185 is authorized to access the requested application, the SP may grant the user 185 access to the requested applications 110, for example, without prompting the user 185 to enter credentials (e.g., without prompting the user to log-in). The SSO service 155 may promote improved user experience (e.g., by limiting the number of credentials the user 185 has to remember/enter), enhanced security (e.g., by leveraging secure authentication protocols and centralized security policies), and reduced credential fatigue, among other benefits.

The MFA service 160 of the identity management system 120 may enhance the security of the computing system 100 by prompting the user 185 to provide multiple authentication factors before granting the user 185 access to applications 110. These authentication factors may include one or more knowledge factors (e.g., something the user 185 knows, such as a password), one or more possession factors (e.g., something the user 185 is in possession of, such as a mobile app-generated code or a hardware token), or one or more inherence factors (e.g., something inherent to the user 185, such as a fingerprint or other biometric information). In some implementations, the MFA service 160 may be used in conjunction with the SSO service 155. For example, the user 185 may provide the requested login credentials to the identity management system 120 in accordance with an SSO flow and, in response, the identity management system 120 may prompt the user 185 to provide a second factor, such as a possession factor (e.g., a one-time passcode (OTP), a hardware token, a text message code, an email link/code). The user 185 may obtain access (e.g., be granted access by the identity management system 120) to the requested applications 110 based on successful verification of both the first authentication factor and the second authentication factor.

The API service 165 of the identity management system 120 can secure APIs by managing access tokens and API keys for various client organizations, which may enable (e.g., only enable) authorized applications (e.g., one or more of the applications 110) and authorized users (e.g., the user 185) to interact with a client organization's APIs. The API service 165 may enable client organizations to implement customizable login experiences that are consistent with their architecture, brand, and security configuration. The API service 165 may enable administrators to control user API access (e.g., whether the user 185 and/or one or more other users have access to one or more particular APIs). In some examples, the API service 165 may enable administrators to control API access for users via authorization policies, such as standards-based authorization policies that leverage OAuth 2.0. The API service 165 may additionally, or alternatively, implement role-based access control (RBAC) for applications 110. In some implementations, the API service 165 can be used to configure user lifecycle policies that automate API onboarding and off-boarding processes.

The directory management service 170 may enable the identity management system 120 to integrate with various identity sources of client organizations. In some implementations, the directory management service 170 may communicate with a directory service 145 of the on-premises system 115 via a software agent 150 installed on one or more computers, servers, and/or devices of the on-premises system 115. Additionally, or alternatively, the directory management service 170 may communicate with one or more other directory services, such as one or more cloud-based directory services. As described herein, a software agent 150 generally refers to a software program or component that operates on a system or device (such as a device of the on-premises system 115) to perform operations or collect data on behalf of another software application or system (such as the identity management system 120).

The provisioning service 175 of the identity management system 120 may support user provisioning and deprovisioning. For example, in response to an employee joining a client organization, the identity management system 120 may automatically create accounts for the employee and provide the employee with access to one or more resources via the accounts. Similarly, in response to the employee (or some other employee) leaving the client organization, the identity management system 120 may autonomously deprovision the employee's accounts and revoke the employee's access to the one or more resources (e.g., with little to no intervention from the client organization). The provisioning service 175 may maintain audit logs and records of user deprovisioning events, which may help the client organization demonstrate compliance and track user lifecycle changes. In some implementations, the provisioning service 175 may enable administrators to map user attributes and roles (e.g., permissions, privileges) between the identity management system 120 and connected applications 110, ensuring that user profiles are consistent across the identity management system 120, the on-premises system 115, and the cloud system 125.

Although not depicted in the example of FIG. 1, a person skilled in the art would appreciate that the identity management system 120 may support or otherwise provide access to any number of additional or alternative services, applications 110, platforms, providers, or the like. In other words, the functionality of the identity management system 120 is not limited to the exemplary components and services mentioned in the preceding description of the computing system 100. The description herein is provided to enable a person skilled in the art to make or use the present disclosure. Various modifications to the present disclosure will be readily apparent to those skilled in the art, and the generic principles defined herein may be applied to other variations without departing from the scope of the present disclosure. Accordingly, the present disclosure is not limited to the examples and designs described herein, but is to be accorded the broadest scope consistent with the principles and novel features disclosed herein.

The identity management system 120 may support application management for one or more organizations. For example, an administrator of an organization may manage, via an administrator dashboard of the identity management system 120, applications accessible to users 185 of the organization via a user dashboard of the identity management system 120. That is, users 185 of the organization may access applications authorized and managed by the administrator of the organization through a user dashboard of the identity management system 120. However, in some cases, users 185 may sign in to applications unmanaged by the administrator of the organization. For example, users 185 may sign in, using a user profile of the organization, to an application which is not included in a set of applications managed by the administrator and/or not accessible via the user dashboard of the identity management system 120. In such examples, the identity management system 120 may receive notifications of sign-ins or sign-in attempts using the user profile. For example, a browser extension of the identity management system 120 may transmit one or more signals to the identity management system 120 indicating that a user profile of the organization was used to access an unmanaged application. The identity management system 120 may generate a report of occurrences of sign-ins to unmanaged applications, including which unmanaged applications were accessed, user profiles that accessed the unmanaged applications, and a timestamp of a most recent access to the unmanaged applications. Based on the report, the administrator may perform an application management operation via the identity management system 120, including authorizing access to the unmanaged application (e.g., such that the application is accessible via the identity management system 120) or revoking access to the unmanaged application.

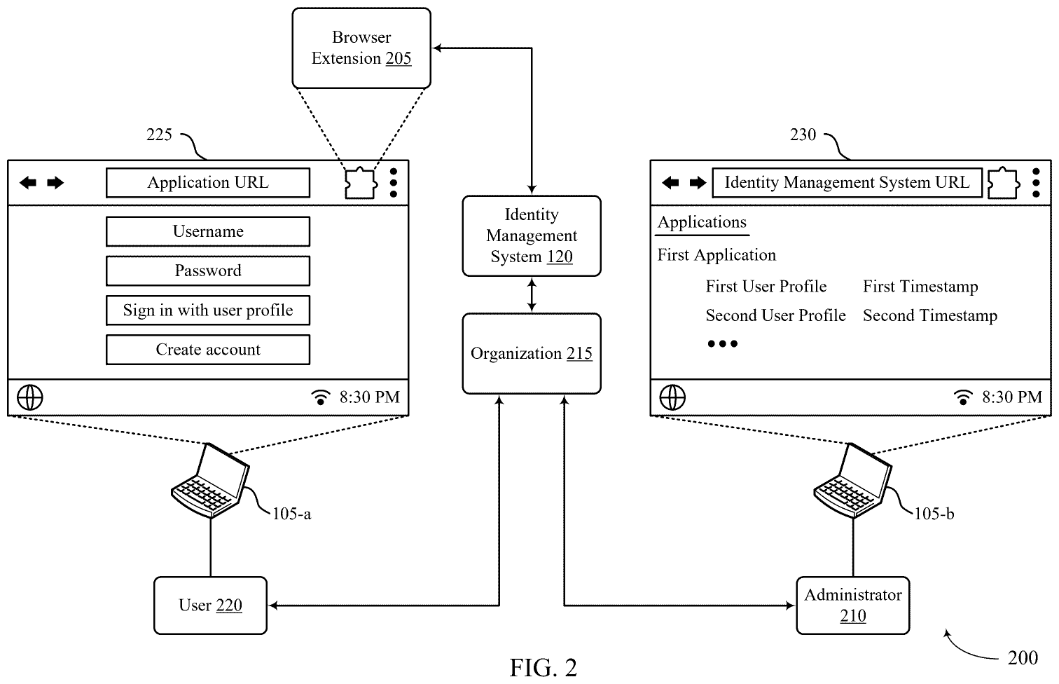

FIG. 2 shows an example of a computing system 200 that supports extra-organizational application management in accordance with aspects of the present disclosure. In some examples, the computing system 200 may implement or be implemented by aspects of the computing system 100. For example, the computing system 200 may include an identity management system 120, which may be an example of the identity management system 120 as described with reference to FIG. 1. Additionally, the computing system 200 may include a user 220 and an administrator 210, which may be examples of a user 185 as described with reference to FIG. 1, and a computing device 105-a and a computing device 105-b, which may be examples of the computing device 105 as described with reference to FIG. 1.

The identity management system 120 may support application management services (e.g., and one or more other services, such as the services and functions as described with reference to FIG. 1) for an organization 215. For example, the administrator 210 of the organization 215 may configure, via an administrator dashboard of the identity management system 120, applications accessible to users of the organization 215 via a user dashboard of the identity management system 120. In some examples, the administrator 210 may configure access to different sets of users, such as configure access to a first set of applications for a first set of users and a second set of applications for a second set of users, where the first set of applications and the second set of applications are at least partially different.

In some cases, users of the organization 215 may access applications which are not managed and/or authorized by the administrator 210. Such access to unmanaged or unauthorized applications as described herein may be referred to as shadow information technology (IT). Shadow IT may refer to systems or applications used by users of the organization 215 which are not centrally managed by the administrator 210 (e.g., a member of an IT department of the organization 215). Access to the applications which are not managed or authorized by the administrator 210 may allow the applications to access information of the organization 215 without permission from the administrator 210 and/or without satisfying an authorization policy of the organization 215.

In the example of FIG. 2, the user 220 of the organization 215 may access an application via a sign-in page 225 of the application. The sign-in page 225 may display, via a user interface of the computing device 105-a, options to sign in via a username and password, sign in with a user profile, or create an account. In a first example, the user 220 may select the option to sign in with the user profile (e.g., perform a social login). The user profile, in the first example, may be a user profile of the organization 215. That is, the user profile may be provisioned by the administrator 210 of the organization, and the user profile may have access to information of the organization 215. In some cases, signing in to the application via the user profile may grant access to the application to access information of the user profile and, by extension, the organization 215. In a second example, the user 220 may select the option to create an account. In the second example, the user 220 may create the account using the user profile (e.g., an email address or username of the user profile) of the organization 215.

In each example, a browser extension 205 of the identity management system 120 may detect the sign-in using a credential of the user profile of the organization 215. For example, the browser extension 205 may identify or otherwise detect selection of the user profile as the sign-in option (e.g., in the first example), input of the username of the user profile as a username while creating an account (e.g., in the second example), or the like. The browser extension 205 may display a notification to the user 220 via the sign-in page 225 of the application (e.g., as a pop-up message), transmit one or more signals to the identity management system 120, or both based on detecting the sign-in using the credential of the user profile.

For example, the browser extension 205 may display a message (e.g., a warning message) indicating that the application is not managed by the organization 215. Additionally, or alternatively, the browser extension 205 may display a message indicating that the sign-in to the application unmanaged by the organization 215 is logged and that the administrator 210 of the organization 215 may be notified of the sign-in. In some examples, the browser extension 205 may block account creation using the username of the user profile. For example, the browser extension 205 may block the account creation based on a policy of the organization 215 (e.g., configured by the administrator 210).

The identity management system 120 may receive the one or more signals indicating that the sign-in to the application via the user profile of the organization 215. The one or more signals may include an identifier of the application, such as a domain or application URL. The identity management system 120, in response to or after receiving the one or more signals, may store information associated with the sign-in. For example, the identity management system 120 may store (e.g., at a database associated with the organization 215) an indication of the user profile, the application, and a timestamp of the sign-in. In some examples, the identity management system 120 may update an administrator dashboard to indicate the sign-in. For example, the identity management system 120 may update the administrator dashboard with an indication of the application, the user profile, and a timestamp of the sign-in. Additionally, or alternatively, the identity management system 120 may initiate transmission of a message, such as an email, to be sent to the user 220, the administrator 210, or both indicating the sign-in. For example, the message may include the indication of the application, the user profile, and the timestamp of the sign-in. In some examples, the identity management system 120 may initiate transmission of the message by transmitting one or more API calls, such as to APIs of a service provider of the user profile (e.g., an email service provider). In some examples, the identity management system 120 may receive the one or more signals based on transmitting one or more API calls to the service provider of the user profile. For example, the identity management system 120 may periodically call one or more APIs (e.g., social login APIs) of a service or system that the user profile is registered on to obtain information about sign-in events for the user profile.

The administrator 210, via the administrator dashboard, may view information associated with sign-ins of the user profile, among other user profiles of the organization 215, to applications managed and/or unmanaged by the organization 215. For example, the administrator 210 may provide one or more inputs, via a user interface of the computing device 105-b, to the identity management system 120 to display information associated with sign-ins to unmanaged applications by user profiles of the organization. In response to or after receiving the one or more inputs, the identity management system 120 may display a report page 230. The report page 230 may include one or more applications that are unmanaged by the organization 215 which were accessed by user profiles of the organization 215, which user profiles of the organization 215 accessed the one or more applications, and timestamps of access. Additionally, or alternatively, the report page 230 may include options to perform one or more application management operations for the one or more applications. For example, the administrator 210 may provide, via the report page 230, inputs to perform application management operations.

The application management operations may include, as examples, providing authorized and/or managed access to an application or revoking access to the application. For example, the administrator 210 may obtain access to the application via an agreement between the application and the organization 215 such that the application is accessible via the identity management system 120. In other words, the administrator 210 may configure access to the application for one or more user profiles of the organization 215, where the access to the application satisfies a policy of the organization 215 (e.g., an access policy, an authorization policy, a security policy, a data sharing policy, etc.). In some examples, the administrator 210 may request access to the application via the identity management system 120. For example, in examples in which the application is not supported by the identity management system 120 (e.g., the administrator 210 is not able to add the application as a managed application), the administrator 210 may submit a request to the identity management system 120 indicating the application. Additionally, or alternatively, the administrator 210 may revoke access to the application. That is, the administrator 210 may configure the browser extension 205 to block sign-in attempts using user profiles of the organization.

In some examples, the administrator 210 may perform different application management operations for different user profiles of the organization 215. As an example, the administrator 210 may revoke access to an application for first user profiles of the organization 215 and grant access (e.g., via the identity management system 120) to second user profiles of the organization 215.

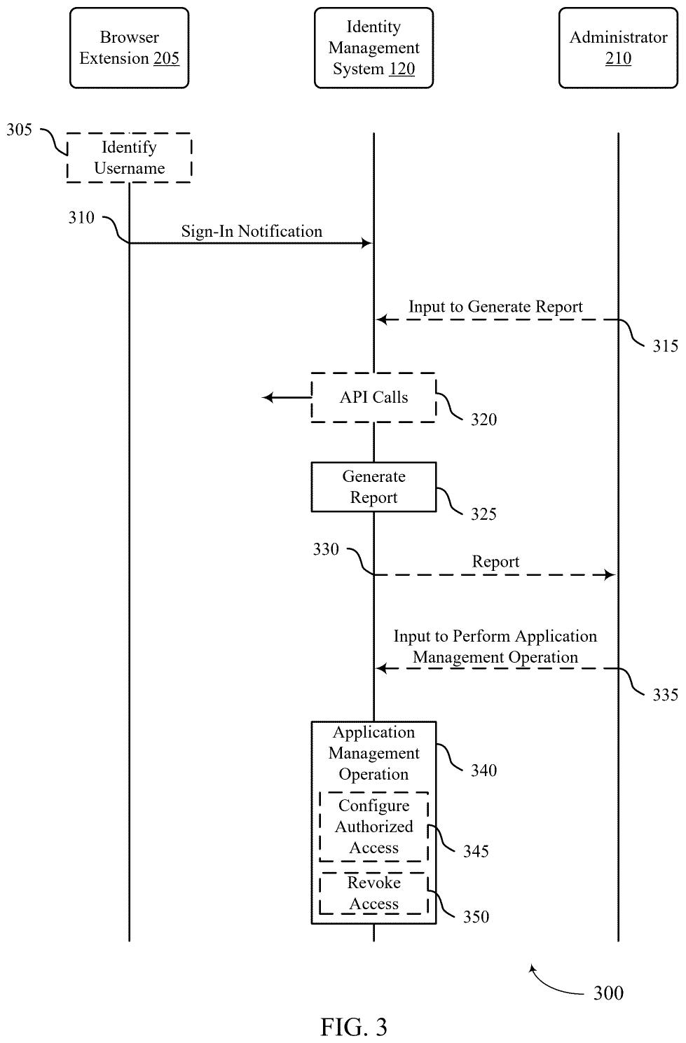

FIG. 3 shows an example of a process flow 300 that supports extra-organizational application management in accordance with aspects of the present disclosure. In some examples, the process flow 300 may implement aspects of the computing system 100, the computing system 200, or both. The process flow 300 may illustrate operations of a browser extension 205, an identity management system 120, and an administrator 210, which may be examples of corresponding devices as described with reference to FIGS. 1 and 2.

In the following description of the process flow 300, the operations performed at the browser extension 205, the identity management system 120, and the administrator 210 may be performed in different orders or at different times than shown. While the operations of the process flow 300 are illustrated and described as being performed by the browser extension 205, the identity management system 120, and the administrator 210, the operations described herein may be performed at one or more other devices or systems. Additionally, or alternatively, some operations may be omitted from the process flow 300 and other operations may be added to the process flow 300.

At 305, the browser extension 205 may identify a username. For example, the browser extension 205 may be installed on a user device of a user of an organization supported by the identity management system 120. The user device and the user may be examples of the computing device 105-a and the user 220 as described with reference to FIG. 2. The browser extension 205 may be associated with or otherwise a part of the identity management system 120. The browser extension 205 may monitor inputs to fields in a browser of the user device to identify whether a username of a first user profile of the organization is used to sign in to a first application. In some examples, the browser extension 205 may identify the username and display one or more messages via a user interface of the user device based on a policy configured by the administrator 210 of the organization. Additionally, or alternatively, the browser extension 205 may identify a user entry into one or more password fields, such as a HyperText Markup Language (HTML) password field. For example, the browser extension 205 may identify the username based on detecting an input to the one or more password fields. In some examples, the browser extension 205 may additionally or alternatively identify the username based on a log-in field, URL, or both which was previously identified by the browser extension 205 or the identity management system 120.

At 310, the browser extension 205 may transmit a sign-in notification to the identity management system 120. For example, the browser extension 205 may transmit one or more signals associated with a sign-in to a first application via a first user profile of the organization. In other words, the identity management system 120 may receive one or more signals associated with a sign-in to a first application via a first user profile of the organization. The first application may disassociated with a first set of applications having been authorized access by the administrator 210 of the organization via the identity management system 120. That is, the first application may not be managed or authorized by the administrator 210, be inaccessible via the identity management system 120 (e.g., via a user dashboard of the identity management system 120 for the first user profile), or both.

In some examples, the one or more signals may include a domain of the first application. That is, the one or more signals may not include a credential of the first user profile. Additionally, or alternatively, the one or more signals may be received based on an input to the first application for the sign-in having a same username as the first user profile of the organization. In other words, the one or more signals may be received by the identity management system 120 based on the browser extension 205 identifying the username at 305.

At 315, the administrator 210 may provide an input to generate a report at the identity management system 120. For example, the administrator 210 may request, via a user interface of a user device (e.g., an administrator dashboard of the identity management system 120), such as the computing device 105-b as described with reference to FGI. 2, information associated with sign-ins by user profiles of the organization to a second set of applications. The second set of applications may be examples of applications disassociated with the first set of applications having been authorized access by the administrator 210. In other words, the administrator 210 may request a summary of unauthorized access to applications by users of the organization.

At 320, the identity management system 120 may transmit one or more API calls. For example, the identity management system 120 may transmit one or more API calls to a provider associated with the user profiles of the organization. The API calls may be configured to obtain sign-in information associated with the user profiles. In some examples, the identity management system 120 may transmit the one or more API calls periodically (e.g., regardless of inputs from the administrator 210). Additionally, or alternatively, the identity management system 120 may transmit the one or more API calls based on receiving the input at 315.

At 325, the identity management system 120 may generate a report. For example, the identity management system 120 may generate a report indicative of the second set of applications accessed via user profiles of the organization, a set of user profiles that accessed the second set of applications, and a timestamp of access to the second set of applications by each of the set of user profiles. The second set of applications may include at least the first application, and the set of user profiles may at least the first user profile (e.g., indicated in the one or more signals at 310). In some examples, generating the report indicative of the second set of applications accessed via the set of user profiles of the organization may be based on transmitting the one or more API calls at 320. That is, the identity management system 120 may obtain the information included in report in response to transmitting the one or more API calls.

At 330, the identity management system 120 may indicate the report to the administrator 210. For example, the identity management system 120 may indicate the report via an administrator dashboard of the administrator 210, such as via a user interface of a computing device of the administrator 210. The indication of the report may be an example of the report page 230 as described with reference to FIG. 2.

At 335, the administrator 210 may provide an input to perform an application management operation. For example, via the user interface displaying the indication of the report, the administrator 210 may provide the input to perform the application management operation for at least one application, at least one user profile, or both of the second set of applications, the set of user profiles, or both included in the report. In other words, the administrator 210 may provide the input via an administrator dashboard of the identity management system 120. The identity management system 120 may receive one or more second signals indicative of the input.

At 340, the identity management system 120 may perform the application management operation. For example, the identity management system 120 may perform the application management operation associated with at least one application of the second set of applications, at least one user profile of the set of user profiles, or both based on generating the report at 325. In some examples, the application management operation may be performed based on a threshold quantity of user profiles accessing the at least one application. For example, the administrator 210 may configure application management operations to be performed (e.g., automatically, triggered, without input, etc.) based on the threshold quantity of user profiles being satisfied. Additionally, or alternatively, the application management operation may be determined via an AI or ML model. For example, the administrator 210 may configure the application management operation to be performed according to the AI or ML model automatically or based on a user input confirming a recommendation of the AI or ML model.

In some examples, at 345, the application management operation may include configuring authorized access. For example, the application management operation may include configuring, by the administrator of the organization via the identity management system 120, the at least one application to have authorized access. The first set of applications may include the at least one application based on configuring the at least one application to have authorized access at 345. For example, one or more users of the organization may access the at least one application via a user dashboard of the identity management system 120.

In some examples, at 350, the application management operation may include revoking access. For example, the identity management system 120 may revoke access to the at least one application. After revoking the access at 350, the identity management system 120 may receive one or more third signals associated with a sign-in attempt to the at least one application, where the sign-in attempt is unsuccessful based on revoking access to the at least one application. That is, subsequent attempts to access the at least one application using a user profile of the organization may be blocked, such as via the browser extension 205.

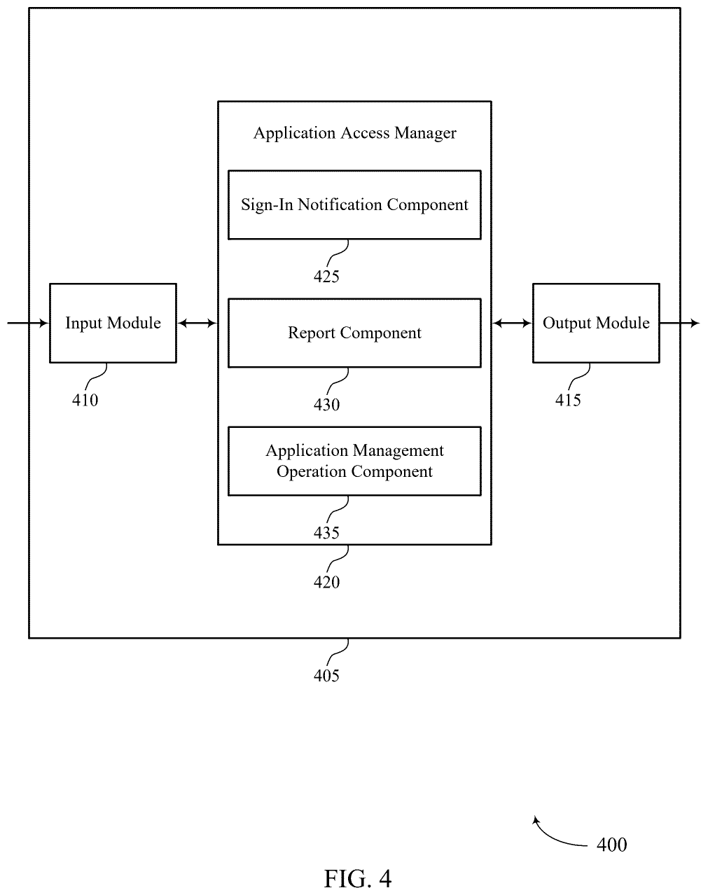

FIG. 4 shows a block diagram 400 of a device 405 that supports extra-organizational application management in accordance with aspects of the present disclosure. The device 405 may include an input module 410, an output module 415, and an application access manager 420. The device 405, or one or more components of the device 405 (e.g., the input module 410, the output module 415, the application access manager 420), may include at least one processor, which may be coupled with at least one memory, to support the described techniques. Each of these components may be in communication with one another (e.g., via one or more buses).

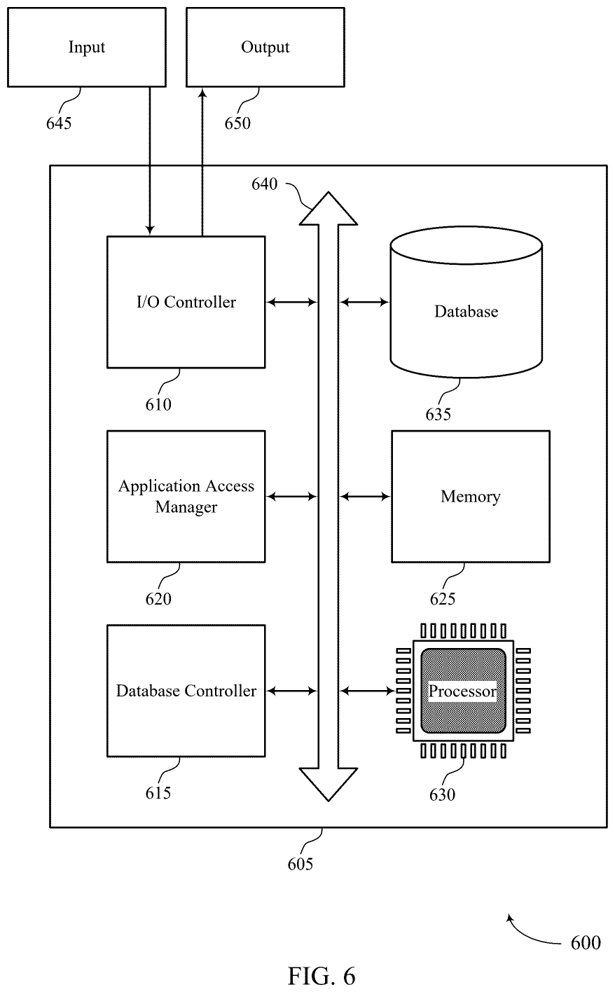

The input module 410 may manage input signals for the device 405. For example, the input module 410 may identify input signals based on an interaction with a modem, a keyboard, a mouse, a touchscreen, or a similar device. These input signals may be associated with user input or processing at other components or devices. In some cases, the input module 410 may utilize an operating system such as iOS®, ANDROID®, MS-DOS®, MS-WINDOWS®, OS/2®, UNIX®, LINUX®, or another known operating system to handle input signals. The input module 410 may send aspects of these input signals to other components of the device 405 for processing. For example, the input module 410 may transmit input signals to the application access manager 420 to support extra-organizational application management. In some cases, the input module 410 may be a component of an input/output (I/O) controller 610 as described with reference to FIG. 6.

The output module 415 may manage output signals for the device 405. For example, the output module 415 may receive signals from other components of the device 405, such as the application access manager 420, and may transmit these signals to other components or devices. In some examples, the output module 415 may transmit output signals for display in a user interface, for storage in a database or data store, for further processing at a server or server cluster, or for any other processes at any number of devices or systems. In some cases, the output module 415 may be a component of an I/O controller 610 as described with reference to FIG. 6.

For example, the application access manager 420 may include a sign-in notification component 425, a report component 430, an application management operation component 435, or any combination thereof. In some examples, the application access manager 420, or various components thereof, may be configured to perform various operations (e.g., receiving, monitoring, transmitting) using or otherwise in cooperation with the input module 410, the output module 415, or both. For example, the application access manager 420 may receive information from the input module 410, send information to the output module 415, or be integrated in combination with the input module 410, the output module 415, or both to receive information, transmit information, or perform various other operations as described herein.

The application access manager 420 may support managing application access in accordance with examples as disclosed herein. The sign-in notification component 425 may be configured to support receiving one or more signals associated with a sign-in to a first application via a first user profile of the organization, where the first application is disassociated with a first set of multiple applications having been authorized access by an administrator of the organization via the identity management system. The report component 430 may be configured to support generating a report indicative of a second set of multiple applications accessed via user profiles of the organization, a set of multiple user profiles that accessed the second set of multiple applications, and a timestamp of access to the second set of multiple applications by each of the set of multiple user profiles, where the second set of multiple applications include at least the first application, and where the set of multiple user profiles include at least the first user profile. The application management operation component 435 may be configured to support performing an application management operation associated with at least one application of the second set of multiple applications, at least one user profile of the set of multiple user profiles, or both based on generating the report.

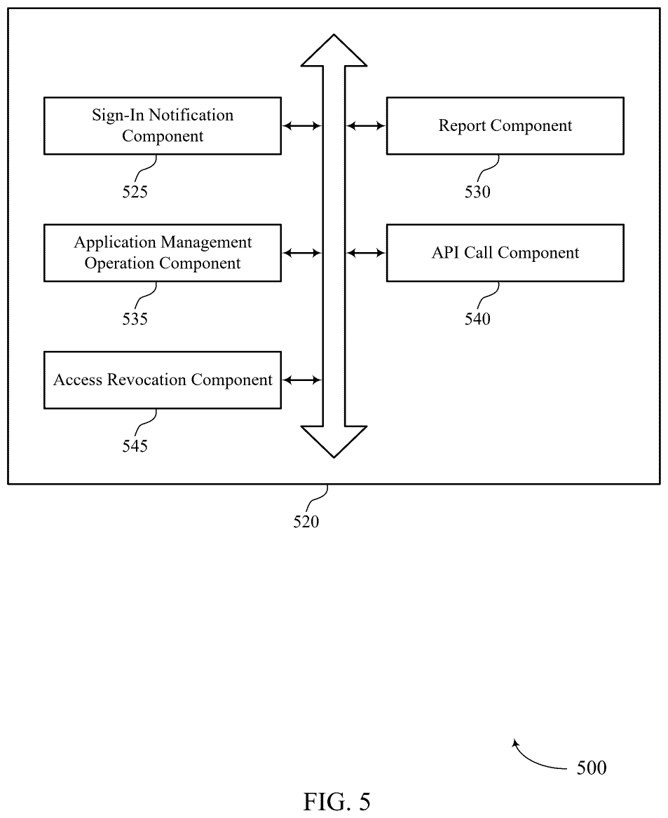

FIG. 5 shows a block diagram 500 of an application access manager 520 that supports extra-organizational application management in accordance with aspects of the present disclosure. The application access manager 520 may be an example of aspects of an application access manager or an application access manager 420, or both, as described herein. The application access manager 520, or various components thereof, may be an example of means for performing various aspects of extra-organizational application management as described herein. For example, the application access manager 520 may include a sign-in notification component 525, a report component 530, an application management operation component 535, an API call component 540, an access revocation component 545, or any combination thereof. Each of these components, or components of subcomponents thereof (e.g., one or more processors, one or more memories), may communicate, directly or indirectly, with one another (e.g., via one or more buses).

The application access manager 520 may support managing application access in accordance with examples as disclosed herein. The sign-in notification component 525 may be configured to support receiving one or more signals associated with a sign-in to a first application via a first user profile of the organization, where the first application is disassociated with a first set of multiple applications having been authorized access by an administrator of the organization via the identity management system. The report component 530 may be configured to support generating a report indicative of a second set of multiple applications accessed via user profiles of the organization, a set of multiple user profiles that accessed the second set of multiple applications, and a timestamp of access to the second set of multiple applications by each of the set of multiple user profiles, where the second set of multiple applications include at least the first application, and where the set of multiple user profiles include at least the first user profile. The application management operation component 535 may be configured to support performing an application management operation associated with at least one application of the second set of multiple applications, at least one user profile of the set of multiple user profiles, or both based on generating the report.

In some examples, to support performing the application management operation, the application management operation component 535 may be configured to support configuring, by the administrator of the organization via the identity management system, the at least one application to have authorized access, where the first set of multiple applications includes the at least one application based on configuring the at least one application to have authorized access.

In some examples, performing the application management operation includes revoking access to the at least one application.

In some examples, the access revocation component 545 may be configured to support receiving, via an administrator dashboard of the identity management system, one or more second signals associated with revoking access to the at least one application.

In some examples, the sign-in notification component 525 may be configured to support receiving one or more second signals associated with a sign-in attempt to the at least one application, where the sign-in attempt is unsuccessful based on revoking access to the at least one application.

In some examples, the application management operation is performed based on a threshold quantity of user profiles accessing the at least one application.

In some examples, the API call component 540 may be configured to support transmitting one or more API calls to a provider associated with the user profiles of the organization, where generating the report indicative of the second set of multiple applications accessed via the user profiles of the organization is based on transmitting the one or more API calls.

In some examples, the one or more signals are received via a browser extension installed in a browser of a first user device associated with the first user profile of the organization.

In some examples, the one or more signals are received based on an input to the first application for the sign-in having a same username as the first user profile of the organization.

In some examples, the one or more signals include a domain of the first application.

In some examples, the application management operation is determined via an AI model.

FIG. 6 shows a diagram of a system 600 including a device 605 that supports extra-organizational application management in accordance with aspects of the present disclosure. The device 605 may be an example of or include components of a device 405 as described herein. The device 605 may include components for bi-directional voice and data communications including components for transmitting and receiving communications, such as an application access manager 620, an I/O controller, such as an I/O controller 610, a database controller 615, at least one memory 625, at least one processor 630, and a database 635. These components may be in electronic communication or otherwise coupled (e.g., operatively, communicatively, functionally, electronically, electrically) via one or more buses (e.g., a bus 640).

The I/O controller 610 may manage input signals 645 and output signals 650 for the device 605. The I/O controller 610 may also manage peripherals not integrated into the device 605. In some cases, the I/O controller 610 may represent a physical connection or port to an external peripheral. In some cases, the I/O controller 610 may utilize an operating system such as iOS®, ANDROID®, MS-DOS®, MS-WINDOWS®, OS/2®, UNIX®, LINUX®, or another known operating system. In other cases, the I/O controller 610 may represent or interact with a modem, a keyboard, a mouse, a touchscreen, or a similar device. In some cases, the I/O controller 610 may be implemented as part of a processor 630. In some examples, a user may interact with the device 605 via the I/O controller 610 or via hardware components controlled by the I/O controller 610.

The database controller 615 may manage data storage and processing in a database 635. In some cases, a user may interact with the database controller 615. In other cases, the database controller 615 may operate automatically without user interaction. The database 635 may be an example of a single database, a distributed database, multiple distributed databases, a data store, a data lake, or an emergency backup database.

Memory 625 may include random-access memory (RAM) and read-only memory (ROM). The memory 625 may store computer-readable, computer-executable software including instructions that, when executed, cause at least one processor 630 to perform various functions described herein. In some cases, the memory 625 may contain, among other things, a basic I/O system (BIOS) which may control basic hardware or software operation such as the interaction with peripheral components or devices. The memory 625 may be an example of a single memory or multiple memories. For example, the device 605 may include one or more memories 625.

The processor 630 may include an intelligent hardware device (e.g., a general-purpose processor, a digital signal processor (DSP), a central processing unit (CPU), a microcontroller, an application-specific integrated circuit (ASIC), a field-programmable gate array (FPGA), a programmable logic device, a discrete gate or transistor logic component, a discrete hardware component, or any combination thereof). In some cases, the processor 630 may be configured to operate a memory array using a memory controller. In other cases, a memory controller may be integrated into the processor 630. The processor 630 may be configured to execute computer-readable instructions stored in at least one memory 625 to perform various functions (e.g., functions or tasks supporting extra-organizational application management). The processor 630 may be an example of a single processor or multiple processors. For example, the device 605 may include one or more processors 630.

The application access manager 620 may support managing application access in accordance with examples as disclosed herein. For example, the application access manager 620 may be configured to support receiving one or more signals associated with a sign-in to a first application via a first user profile of the organization, where the first application is disassociated with a first set of multiple applications having been authorized access by an administrator of the organization via the identity management system. The application access manager 620 may be configured to support generating a report indicative of a second set of multiple applications accessed via user profiles of the organization, a set of multiple user profiles that accessed the second set of multiple applications, and a timestamp of access to the second set of multiple applications by each of the set of multiple user profiles, where the second set of multiple applications include at least the first application, and where the set of multiple user profiles include at least the first user profile. The application access manager 620 may be configured to support performing an application management operation associated with at least one application of the second set of multiple applications, at least one user profile of the set of multiple user profiles, or both based on generating the report.

By including or configuring the application access manager 620 in accordance with examples as described herein, the device 605 may support techniques for improved security related to application access by users of an organization.

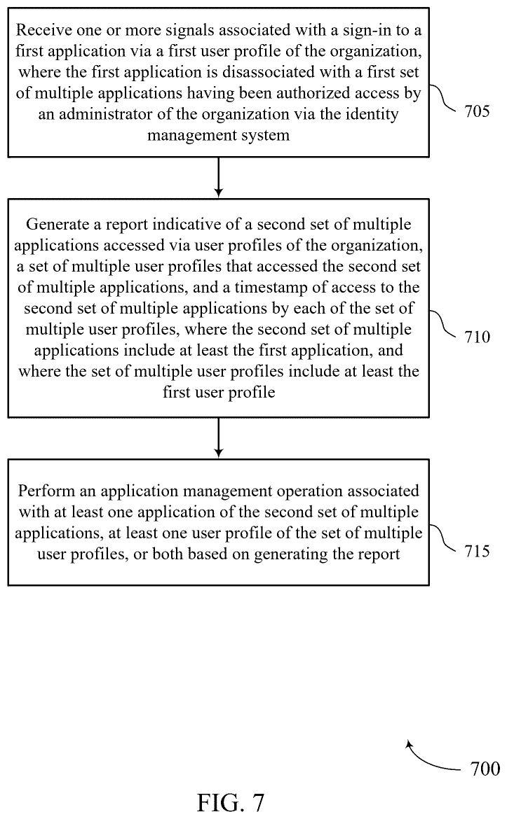

FIG. 7 shows a flowchart illustrating a method 700 that supports extra-organizational application management in accordance with aspects of the present disclosure. The operations of the method 700 may be implemented by an Okta Device or its components as described herein. For example, the operations of the method 700 may be performed by an Okta Device as described with reference to FIGS. 1 through 6. In some examples, an Okta Device may execute a set of instructions to control the functional elements of the Okta Device to perform the described functions. Additionally, or alternatively, the Okta Device may perform aspects of the described functions using special-purpose hardware.

At 705, the method may include receiving one or more signals associated with a sign-in to a first application via a first user profile of the organization, where the first application is disassociated with a first set of multiple applications having been authorized access by an administrator of the organization via the identity management system. The operations of 705 may be performed in accordance with examples as disclosed herein. In some examples, aspects of the operations of 705 may be performed by a sign-in notification component 525 as described with reference to FIG. 5.

At 710, the method may include generating a report indicative of a second set of multiple applications accessed via user profiles of the organization, a set of multiple user profiles that accessed the second set of multiple applications, and a timestamp of access to the second set of multiple applications by each of the set of multiple user profiles, where the second set of multiple applications include at least the first application, and where the set of multiple user profiles include at least the first user profile. The operations of 710 may be performed in accordance with examples as disclosed herein. In some examples, aspects of the operations of 710 may be performed by a report component 530 as described with reference to FIG. 5.

At 715, the method may include performing an application management operation associated with at least one application of the second set of multiple applications, at least one user profile of the set of multiple user profiles, or both based on generating the report. The operations of 715 may be performed in accordance with examples as disclosed herein. In some examples, aspects of the operations of 715 may be performed by an application management operation component 535 as described with reference to FIG. 5.

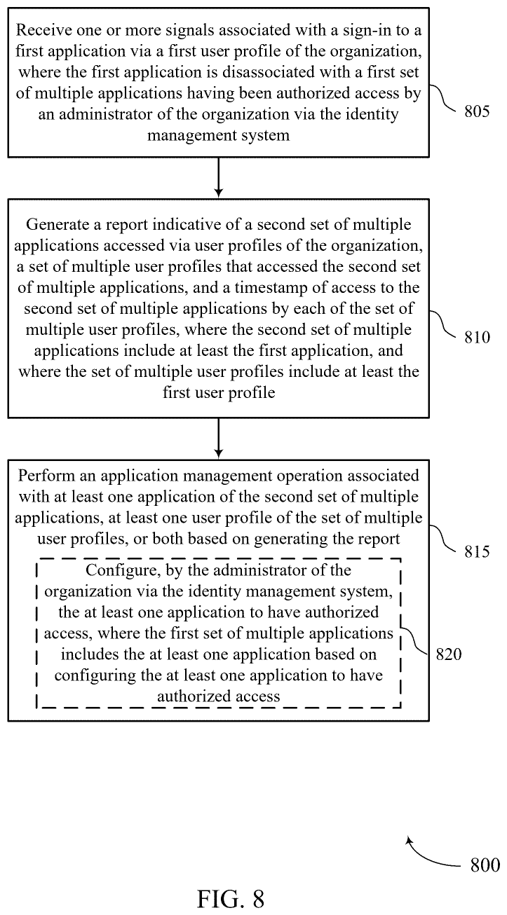

FIG. 8 shows a flowchart illustrating a method 800 that supports extra-organizational application management in accordance with aspects of the present disclosure. The operations of the method 800 may be implemented by an Okta Device or its components as described herein. For example, the operations of the method 800 may be performed by an Okta Device as described with reference to FIGS. 1 through 6. In some examples, an Okta Device may execute a set of instructions to control the functional elements of the Okta Device to perform the described functions. Additionally, or alternatively, the Okta Device may perform aspects of the described functions using special-purpose hardware.

At 805, the method may include receiving one or more signals associated with a sign-in to a first application via a first user profile of the organization, where the first application is disassociated with a first set of multiple applications having been authorized access by an administrator of the organization via the identity management system. The operations of 805 may be performed in accordance with examples as disclosed herein. In some examples, aspects of the operations of 805 may be performed by a sign-in notification component 525 as described with reference to FIG. 5.

At 810, the method may include generating a report indicative of a second set of multiple applications accessed via user profiles of the organization, a set of multiple user profiles that accessed the second set of multiple applications, and a timestamp of access to the second set of multiple applications by each of the set of multiple user profiles, where the second set of multiple applications include at least the first application, and where the set of multiple user profiles include at least the first user profile. The operations of 810 may be performed in accordance with examples as disclosed herein. In some examples, aspects of the operations of 810 may be performed by a report component 530 as described with reference to FIG. 5.

At 815, the method may include performing an application management operation associated with at least one application of the second set of multiple applications, at least one user profile of the set of multiple user profiles, or both based on generating the report. The operations of 815 may be performed in accordance with examples as disclosed herein. In some examples, aspects of the operations of 815 may be performed by an application management operation component 535 as described with reference to FIG. 5.

At 820, performing the application management operation may include configuring, by the administrator of the organization via the identity management system, the at least one application to have authorized access, where the first set of multiple applications includes the at least one application based on configuring the at least one application to have authorized access. The operations of 820 may be performed in accordance with examples as disclosed herein. In some examples, aspects of the operations of 820 may be performed by an application management operation component 535 as described with reference to FIG. 5.

The following provides an overview of aspects of the present disclosure:

Aspect 1: A method for managing application access by an organization via an identity management system, comprising: receiving one or more signals associated with a sign-in to a first application via a first user profile of the organization, wherein the first application is disassociated with a first plurality of applications having been authorized access by an administrator of the organization via the identity management system; generating a report indicative of a second plurality of applications accessed via user profiles of the organization, a plurality of user profiles that accessed the second plurality of applications, and a timestamp of access to the second plurality of applications by each of the plurality of user profiles, wherein the second plurality of applications comprise at least the first application, and wherein the plurality of user profiles comprise at least the first user profile; and performing an application management operation associated with at least one application of the second plurality of applications, at least one user profile of the plurality of user profiles, or both based at least in part on generating the report.

Aspect 2: The method of aspect 1, wherein performing the application management operation comprises: configuring, by the administrator of the organization via the identity management system, the at least one application to have authorized access, wherein the first plurality of applications comprises the at least one application based at least in part on configuring the at least one application to have authorized access.

Aspect 3: The method of any of aspects 1 through 2, wherein performing the application management operation comprises revoking access to the at least one application.

Aspect 4: The method of aspect 3, further comprising: receiving, via an administrator dashboard of the identity management system, one or more second signals associated with revoking access to the at least one application.

Aspect 5: The method of any of aspects 3 through 4, further comprising: receiving one or more second signals associated with a sign-in attempt to the at least one application, wherein the sign-in attempt is unsuccessful based at least in part on revoking access to the at least one application.

Aspect 6: The method of any of aspects 1 through 5, wherein the application management operation is performed based at least in part on a threshold quantity of user profiles accessing the at least one application.

Aspect 7: The method of any of aspects 1 through 6, further comprising: transmitting one or more API calls to a provider associated with the user profiles of the organization, wherein generating the report indicative of the second plurality of applications accessed via the user profiles of the organization is based at least in part on transmitting the one or more API calls.

Aspect 8: The method of any of aspects 1 through 7, wherein the one or more signals are received via a browser extension installed in a browser of a first user device associated with the first user profile of the organization.

Aspect 9: The method of any of aspects 1 through 8, wherein the one or more signals are received based at least in part on an input to the first application for the sign-in having a same username as the first user profile of the organization.

Aspect 10: The method of any of aspects 1 through 9, wherein the one or more signals comprise a domain of the first application.

Aspect 11: The method of any of aspects 1 through 10, wherein the application management operation is determined via an AI model.

Aspect 12: An organization via an identity management system for managing application access, comprising one or more memories storing processor-executable code, and one or more processors coupled with the one or more memories and individually or collectively operable to execute the code to cause the organization via an identity management system to perform a method of any of aspects 1 through 11.

Aspect 13: An organization via an identity management system for managing application access, comprising at least one means for performing a method of any of aspects 1 through 11.

Aspect 14: A non-transitory computer-readable medium storing code for managing application access, the code comprising instructions executable by one or more processors to perform a method of any of aspects 1 through 11.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations, and does not represent all the examples that may be implemented, or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by one or more processors, firmware, or any combination thereof. If implemented in software executed by one or more processors, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable ROM (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for managing application access by an organization via an identity management system, comprising:
receiving one or more signals associated with a sign-in to a first application via a first user profile of the organization, wherein the first application is disassociated with a first plurality of applications having been authorized access by an administrator of the organization via the identity management system;
generating a report indicative of a second plurality of applications accessed via user profiles of the organization, a plurality of user profiles that accessed the second plurality of applications, and a timestamp of access to the second plurality of applications by each of the plurality of user profiles, wherein the second plurality of applications comprise at least the first application, and wherein the plurality of user profiles comprise at least the first user profile; and
performing an application management operation associated with at least one application of the second plurality of applications, at least one user profile of the plurality of user profiles, or both based at least in part on generating the report.

2. The method of claim 1, wherein performing the application management operation comprises:
configuring, by the administrator of the organization via the identity management system, the at least one application to have authorized access, wherein the first plurality of applications comprises the at least one application based at least in part on configuring the at least one application to have authorized access.

3. The method of claim 1, wherein performing the application management operation comprises revoking access to the at least one application.

4. The method of claim 3, further comprising:
receiving, via an administrator dashboard of the identity management system, one or more second signals associated with revoking access to the at least one application.

5. The method of claim 3, further comprising:
receiving one or more second signals associated with a sign-in attempt to the at least one application, wherein the sign-in attempt is unsuccessful based at least in part on revoking access to the at least one application.

6. The method of claim 1, wherein the application management operation is performed based at least in part on a threshold quantity of user profiles accessing the at least one application.

7. The method of claim 1, further comprising:
transmitting one or more application programming interface (API) calls to a provider associated with the user profiles of the organization, wherein generating the report indicative of the second plurality of applications accessed via the user profiles of the organization is based at least in part on transmitting the one or more API calls.

8. The method of claim 1, wherein the one or more signals are received via a browser extension installed in a browser of a first user device associated with the first user profile of the organization.

9. The method of claim 1, wherein the one or more signals are received based at least in part on an input to the first application for the sign-in having a same username as the first user profile of the organization.

10. The method of claim 1, wherein the one or more signals comprise a domain of the first application.

11. The method of claim 1, wherein the application management operation is determined via an artificial intelligence model.

12. An identity management system for managing application access by an organization, comprising:
one or more memories storing processor-executable code; and
one or more processors coupled with the one or more memories and individually or collectively operable to execute the code to cause the identity management system to:
receive one or more signals associated with a sign-in to a first application via a first user profile of the organization, wherein the first application is disassociated with a first plurality of applications having been authorized access by an administrator of the organization via the identity management system;
generate a report indicative of a second plurality of applications accessed via user profiles of the organization, a plurality of user profiles that accessed the second plurality of applications, and a timestamp of access to the second plurality of applications by each of the plurality of user profiles, wherein the second plurality of applications comprise at least the first application, and wherein the plurality of user profiles comprise at least the first user profile; and
perform an application management operation associated with at least one application of the second plurality of applications, at least one user profile of the plurality of user profiles, or both based at least in part on generating the report.

13. The identity management system of claim 12, wherein, to perform the application management operation, the one or more processors are individually or collectively operable to execute the code to cause the identity management system to:
configure, by the administrator of the organization via the identity management system, the at least one application to have authorized access, wherein the first plurality of applications comprises the at least one application based at least in part on configuring the at least one application to have authorized access.

14. The identity management system of claim 12, wherein performing the application management operation comprises revoking access to the at least one application.

15. The identity management system of claim 14, wherein the one or more processors are individually or collectively further operable to execute the code to cause the identity management system to:
receive, via an administrator dashboard of the identity management system, one or more second signals associated with revoking access to the at least one application.

16. The identity management system of claim 14, wherein the one or more processors are individually or collectively further operable to execute the code to cause the identity management system to:
receive one or more second signals associated with a sign-in attempt to the at least one application, wherein the sign-in attempt is unsuccessful based at least in part on revoking access to the at least one application.

17. The identity management system of claim 12, wherein the application management operation is performed based at least in part on a threshold quantity of user profiles accessing the at least one application.

18. The identity management system of claim 12, wherein the one or more processors are individually or collectively further operable to execute the code to cause the identity management system to:
transmit one or more application programming interface (API) calls to a provider associated with the user profiles of the organization, wherein generating the report indicative of the second plurality of applications accessed via the user profiles of the organization is based at least in part on transmitting the one or more API calls.

19. The identity management system of claim 12, wherein the one or more signals are received via a browser extension installed in a browser of a first user device associated with the first user profile of the organization.

20. A non-transitory computer-readable medium storing code for managing application access, the code comprising instructions executable by one or more processors to:
receive one or more signals associated with a sign-in to a first application via a first user profile of an organization, wherein the first application is disassociated with a first plurality of applications having been authorized access by an administrator of the organization via an identity management system;
generate a report indicative of a second plurality of applications accessed via user profiles of the organization, a plurality of user profiles that accessed the second plurality of applications, and a timestamp of access to the second plurality of applications by each of the plurality of user profiles, wherein the second plurality of applications comprise at least the first application, and wherein the plurality of user profiles comprise at least the first user profile; and
perform an application management operation associated with at least one application of the second plurality of applications, at least one user profile of the plurality of user profiles, or both based at least in part on generating the report.
